(19) United States
(12) Patent Application Publication
(10) Pub. No.: US 2005/0206715 A1
(43) Pub. Date: Sep. 22, 2005

(54) Roll paper, roll paper printer and roll paper print method

(75) Inventors: Hidemi Sasaki, Saitama (JP); Yoshiki Takeoka, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/080,967

(22) Filed: Mar. 16, 2005

(30) Foreign Application Priority Data
Mar. 16, 2004 (JP) 2004-074818

(51) Int. Cl. B41J 2/325; B41J 17/28; G03G 15/00; B41J 17/30

(52) U.S. Cl. 347/221

(57) ABSTRACT

A roll paper comprises a continuous thermal recording paper and a cylindrical core. Line-shaped rear edge marks are formed at intervals of a peripheral length of the core on the thermal recording paper wound close to the core, by a step of the rear edge. An end hole, indicating the thermal recording paper is running out, is formed on the second rear edge mark from the rear edge of the thermal recording paper. End hole marks by the end hole are formed at intervals of the peripheral length of the core. Then end hole marks overlap the rear edge marks. By detecting the end hole, positions of the rear edge marks and the end hole marks are identified based on the peripheral length of the core, and printing of image frames are performed avoiding disposal areas including the rear edge marks and the end hole marks.

### BACKGROUND OF THE INVENTION

1. Field of the Invention

The present invention relates to a roll paper formed of a rolled-up continuous recording paper, a printer and a print method that use the roll paper.

2. Background Arts

A roll paper printer is well known to use a roll paper formed of a continuous recording paper wound about a cylindrical core and to print image frames on a recording paper while drawing the recording paper from the roll paper. Such roll paper printer would be a direct thermal printer that uses a thermal recording paper as a recording paper and thermally prints image frames on a thermal recording paper by giving heat energy to the thermal recording paper with a thermal head, or an inkjet printer that uses a smooth-surfaced thick paper and prints image frames by ejecting ink onto the surface of the paper.

The roll paper is provided with an end mark or an end hole to indicate that the recording paper is running out. Such end mark is, for example, a band of colored area extending for a predetermined length from a rear edge of the recording paper, or a colored area provided on the periphery of the core to be detected by a sensor, as disclosed in Japanese Patent Laid-Open Publication Number 05-155168. The end hole is a circular opening formed at a predetermined distance from the rear edge of the recording paper.

When detecting the end mark, the roll printer using the roll paper stated above sounds the alarm to inform a user that only a small quantity of the recording paper is remained and cancels printing.

On the other hand, Japanese Patent Laid-Open Publication Number 11-138953 discloses a printer that continues printing even when detecting the rear edge of the recording paper in printing, provided that the number of lines to be recorded is within the line number equivalent to the length between a recording head and a paper end sensor.

In many cases, the roll paper still has printable areas for one or two L-size prints, when the end mark or the rear edge of the recording paper is detected. However, the residual recording paper is imprinted with line-shaped rear edge marks at the portion overlapping the rear edge, due to a step formed by the thickness of the recording paper at the rear edge.

Furthermore, the recording paper having the end hole is imprinted with marks of the end hole (hereinafter referred to as end hole marks) at the portion overlapping the end hole. The end hole is formed at one or two L-size print length from the rear edge, and causes the end hole marks between third and fifth recording areas from the rear edge.

The rear edge marks and the end hole marks cause uneven density of the image frame thereon. For that reason, the part of the recording paper having the rear edge mark and the end hole marks, which is equivalent to a space for five L-size prints, is discarded. Such from the roll paper. Based on the peripheral length of the core and the detected position of the end hole, the positions of each rear edge mark are detected. A specific frame size and its printable number are determined based on the positions of each rear edge mark. Printing is suspended if the image frame under printing overlaps with the disposal area of a predetermined width including the rear edge mark. After the print suspension, the specific frame size and its printable number are displayed for confirmation. The image frame of the specific size is printed avoiding the disposal area in accordance with a print command.

According to the present invention, it is possible to efficiently use the recording paper, since the end hole is formed on one of the rear edge marks. That is to say, the recording paper having the end hole that overlaps the rear edge mark has less disposal area, since the area carrying either rear edge mark or end hole is no longer printable.

The present invention enables to prevent uneven density caused by the rear edge marks and the end hole marks, since the image frame is recorded on the recording paper avoiding the disposal area including the rear edge mark. Moreover, printing the image frame between disposal areas, the present invention is capable of eliminating waste of the recording paper.

### BRIEF DESCRIPTION OF THE DRAWINGS

One with ordinary skill in the art would easily understand the above-described objects and advantages of the present invention when the following detailed waste of the recording paper has been acknowledged as a problem.

### SUMMARY OF THE INVENTION

An object of the present invention is to provide a roll paper that is capable of reducing the part to be wasted, and a roll paper printer and a print method both using such a roll paper.

In order to achieve the above object and other objects, the roll paper of the present invention is a continuous recording paper provided with an end hole formed on one of rear edge marks. The end hole indicates that the recording paper is running out. The recording paper is wound about a periphery of a core with its rear edge fixed to the core. Due to a step formed by the rear edge and the core, the recording paper is imprinted with the rear edge marks at regular intervals. In a preferable embodiment of the present invention, the end hole is formed at 2×L from the rear edge, provided that the L represents the peripheral length of the core. The center of the end hole is positioned on the rear edge mark.

The printer of the present invention is provided with a sensor for detecting the end hole and a control part. The control part controls the size of an image frame and a recording start position, such that the image frame is recorded on the recording paper avoiding a disposal area of a predetermined width including the rear edge mark.

In the print method of the present invention, the end hole is detected while the recording paper is drawn description is read with reference to the drawings attached hereto.

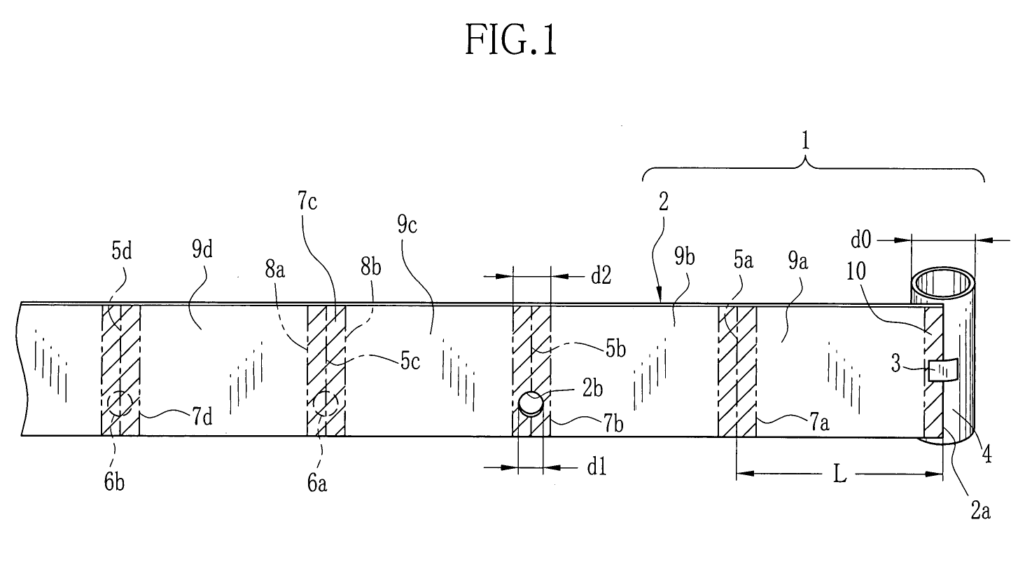

FIG. 1 is an explanatory view illustrating the rear edge area of a recording paper drawn from a core;

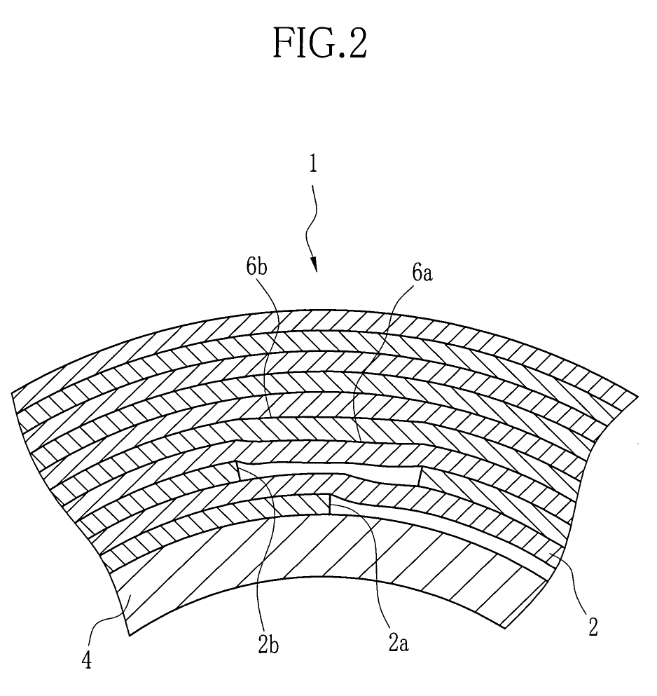

FIG. 2 is a cross sectional view of a roll paper;

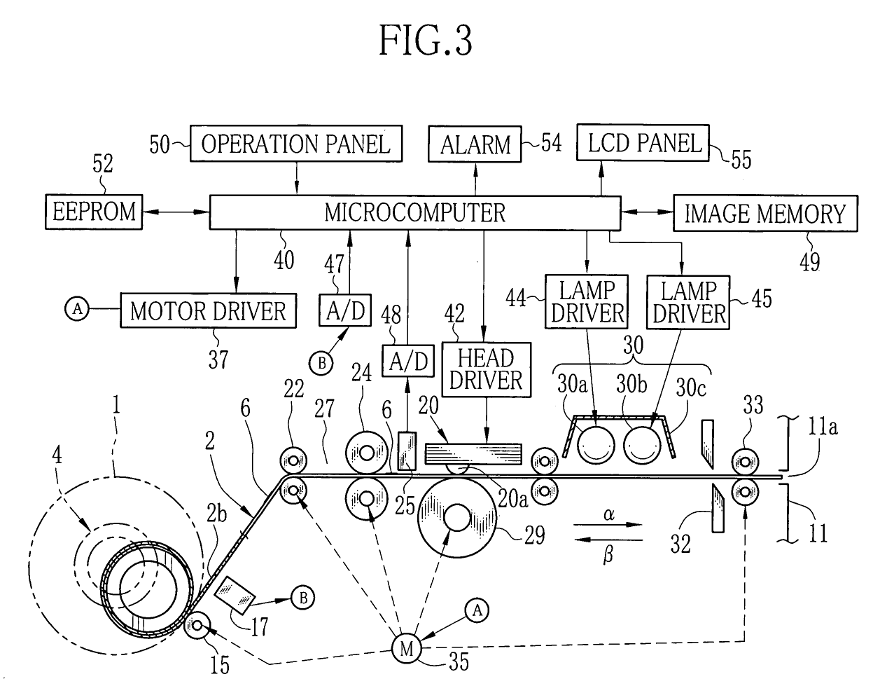

FIG. 3 is a schematic view illustrating a thermal printer; and

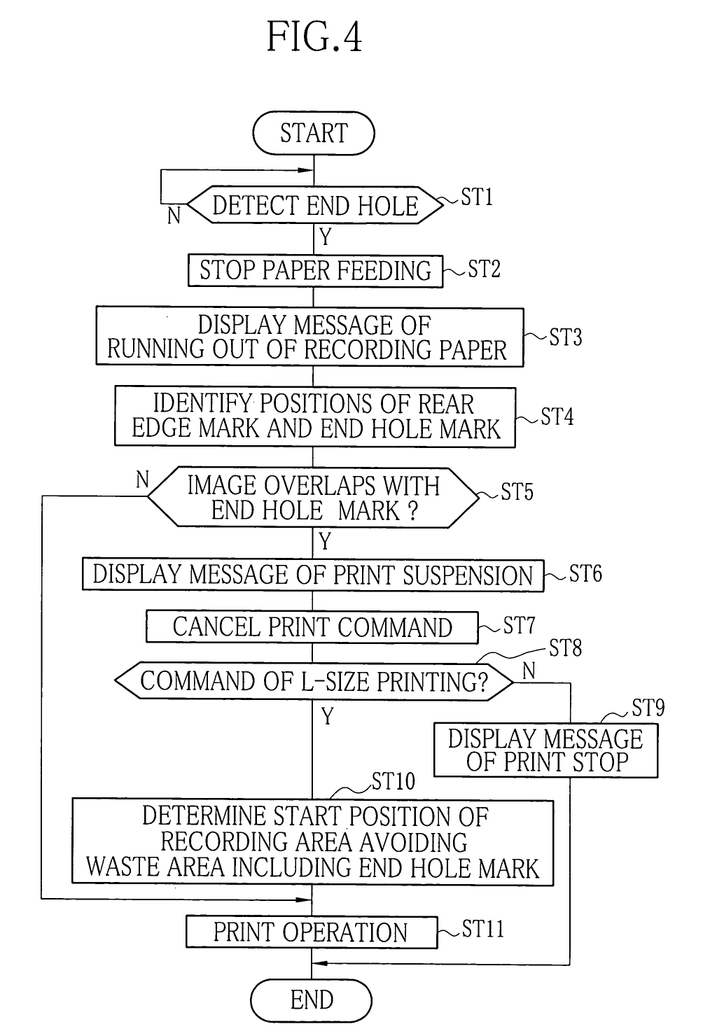

FIG. 4 is a flowchart of print sequence after detection of an end hole.

### PREFERRED EMBODIMENTS OF THE INVENTION

As shown in FIG. 1, a roll paper 1 is a continuous color thermal recording paper (hereinafter referred to as a recording paper) 2 that is wound about a cylindrical core 4 after the central area of its rear edge 2a is fixed to the periphery of the core 4 with an adhesive tape 3. The recording paper 2 has a width of 89 mm, for example. A paper core or a plastic product is used as the core 4, and its diameter d0 is predetermined to two inches (=50.8 mm), for example, in compliance with the industrial standards.

As shown in FIG. 2, the recording paper 2 wound about the core 4 forms a step of a height which corresponds to the thickness of the recording paper 2 at the rear edge 2a. The recording paper 2 wound on the step bends because of the step. Accordingly, when the recording paper 2 is drawn from the roll paper 1, the recording paper 2 bears linear marks (hereinafter referred to as rear edge marks) 5a, 5b, 5c, and 5d at positions N times (N is a counting number) as long as the peripheral length L of the core 4, as shown by the dashed lines in FIG. 1.

In the present embodiment, d0 is 50.8 mm and thus the peripheral length L of the core 4 is 160 mm. The length of the recording paper 2 wound one round of the core 4 becomes longer in proportion to the distance from the core 4, and the interval of the rear edge marks 5a to 5d also becomes longer than the peripheral length L. However, since the rear edge marks are left on the recording paper 2 only within the length of three or four rounds, the actual increase of the interval within that part is very subtle. Accordingly, it is possible to regard the interval to be constant and same length as the peripheral length L. In addition, uneven density caused by the rear edge marks is occurred from the first to the fourth rounds of the recording paper 2 in the present embodiment, that is, the rear edge marks 5a to 5d shown in FIG. 1 should be dealt with.

A circular end hole 2b for indicating running out of the recording paper 2 is formed on the rear edge mark 5b, the second rear edge mark from the rear edge 2a. Since the recording paper 2 wound on the end hole 2b sinks in the end hole 2b, a mark of the end hole (hereinafter referred to as a end hole mark) 2b is formed thereon as shown in FIG. 2. When the recording paper 2 is drawn from the roll paper 1, the recording paper 2 bears circular end hole marks 6a and 6b on the third and the fourth rear edge marks 7c and 7d at intervals of the length equivalent to the peripheral length L, as shown by dashed lines in FIG. 1.

Since the end hole 2b is formed on the rear edge mark 5b, the end hole marks 6a and 6b are left on the rear edge marks 5c and 5d respectively. The end hole marks become fainter in proportion to the distance from the end hole 2b, and the end hole marks after the third one are no longer visible. Accordingly, the object of consideration is only the first and the second end hole marks 6a and 6b with respect to the effects on image quality.

Near the rear edge 2a, image frames are printed avoiding disposal areas (hatched areas between two chain double-dashed lines) 7a, 7b, 7c, and 7d, each of which is formed to include the rear edge marks 5a to 5d respectively at the center of them and has a width of 2d that is wider than the diameter d1 of the end hole 2b. If the d2 is 9 mm, each printable area between the two adjacent disposal areas has a size of 151 mm×89 mm (160 mm−9 m=151 mm), which can accommodate a single L-size print (127 mm×89 mm). If the L-size prints are printed in each printable area 9c and 9d, each printable area 9c and 9d produces a disposal area of 24 mm in width.

Although it is theoretically possible to print four L-size prints to the printable area 9a-9d between the second end hole mark 6b and the rear edge 2a, the printable areas 9a and 9b are unprintable in practice because of physical limitations such as a distance between a roll paper set position and a recording head. Accordingly, printing is performed to the printable areas 9c and 9d and the part from the end hole 2b to the rear edge 2a are discarded in the present embodiment. Note that an area 10 adjacent to the rear edge 2a is a nip margin equivalent to the distance between transportation roller pair and a thermal head if the image frame is printed in the printable area 9a by a printer having no physical limitations as stated above.

Although it is necessary to reciprocate the recording paper 2 both in α and β directions in FIG. 3 in order to print one image frame, it is difficult to accurately reciprocates the area from the end hole 2b and the rear edge 2a of the recording paper 2 because of the foregoing physical limitations. The physical limitations may cause troubles such as misalignment of a recording start position. Although the entire area from the end hole mark 6b to the rear edge 2a is conventionally discarded, the area from the disposal area 7b including the end hole 2b to the rear edge 2a, and two disposal areas 7c and 7d including the end hole marks 6a and 6b respectively are discarded in the present embodiment.

As is known in the art, the recording paper 2 includes a cyan thermosensitive coloring layer, a magenta thermosensitive coloring layer, and a yellow thermosensitive coloring layer that are laid in the stated order on a recording side of a support. The yellow thermosensitive coloring layer on the top of the other two coloring layers is the most thermosensitive of the three coloring layers and develops the yellow color with low thermal energy. The cyan thermosensitive coloring layer, laid under the other two coloring layers, is the least thermosensitive of the three coloring layers and needs high thermal energy to develop the cyan color. The magenta thermal coloring layer develops magenta color, laid between the yellow thermosensitive coloring layer and the cyan thermosensitive coloring layer, develops the magenta color with thermal energy level that is approximately intermediate between one to develop the yellow color by the yellow thermosensitive coloring layer and the other to develop the cyan color by the cyan thermosensitive coloring layer.

The yellow thermosensitive coloring layer loses its ability to develop the color when exposed to ultraviolet rays having an emission wavelength peak at 420 nm, while the magenta thermosensitive coloring layer loses its ability to develop the color when exposed to near ultraviolet rays having the emission wavelength peak at 365 nm.

FIG. 3 shows a color thermal printer (hereinafter referred to as a thermal printer) 11 using the roll paper 1. A guide roller 15 is provided in a position where the continuous recording paper 2 is drawn from the roll paper 1, for preventing the slackness of the recording paper 2 by coming in contact with the periphery of the roll paper 1 all the time. As the recording paper 2 is drawn from the roll paper 1 shown by the chain double-dashed line in FIG. 3, the core 4 moves in the lower right direction along a guide (not shown). The roll paper 1 shown by the solid line means that only a small quantity of the recording paper 2 is remained.

An end hole detective sensor 17, which is, for example, a reflection type photosensor, is provided in a position facing the recording paper 2 in the vicinity of the guide roller 15. In addition, feeding roller pair 22 are provided at the downstream side of the end hole detective sensor 17, for drawing the thermal recording paper 2 from the roll paper 1 and feeding the recording paper 2 toward a thermal head 20.

Transport roller pair 24 and a front end detective sensor 25 are provided in the vicinity of the thermal head 20. The transport roller pair 24 nips the recording paper 2 fed by the feeding roller pair 22 and reciprocates it relatively to the thermal head 20 along an approximately straight transportation path 27. The front end detective sensor 25 is a reflection type photosensor, for example, and detects the front end of the thermal recording paper 2 fed by the transport roller pair 24.

A platen roller 29 is disposed under the transportation path 27 facing a heating element array 20a of the thermal head 20. In addition, an optical fixer 30 is provided at the downstream side of the thermal head 20, and a cutter 32 and discharge roller pair 33 are disposed in the vicinity of the eject opening 11a of the thermal printer 11.

The optical fixer 30 comprises an ultraviolet ray lamp 30a for optically fixing the yellow thermosensitive coloring layer by emitting ultraviolet rays of 420 nm, an ultraviolet ray lamp 30b for optically fixing the magenta thermosensitive coloring layer by emitting near ultraviolet rays of 365 nm, and a reflector 30c disposed behind the lamps 30a and 30b for enhancing the emission efficiency.

The guide roller 15, the feeding roller pair 22, the transport roller pair 24, the platen roller 29 and the discharge roller pair 33 are driven by a stepping motor 35 that is controlled by a microcomputer 40 via a motor driver 37. The microcomputer 40 also controls the thermal head 20 via a head driver 20, and the lamps 30a and 30b via lamp drivers 44 and 45 respectively.

The detection signals outputted by the end hole detective sensor 17 and the front end detective sensor 25 are converted into digital detection data by A/D converters 47 and 48 respectively and inputted into the microcomputer 40. The microcomputer 40 is connected to an operation panel 50 that comprises an image memory 49 for importing image data from an external memory such as a memory card, a size specifying key for inputting a print size, and a print key for outputting a print command, an EEPROM 52 for storing the diameter d0 of the core 4, an alarm 54, and an LCD panel 55 for displaying messages.

The following explains an operation of the thermal printer 11 having the above constitution. The roll paper 1 wound about the core 4 having a standardized diameter is loaded in a roll paper chamber (not shown) in the thermal printer 11. By the feed roller pair 22, the front end of the recording paper 2 is drawn from the roll paper 1 and nipped. When the front end of the recording paper 2 transported toward the thermal head is nipped by the transport roller pair 24, the feed roller pair 22 is displaced to a retreated position not to nip the recording paper 2. Subsequently, the recording paper 2 is transported in the a direction by the transport roller pair 24 until the front end of the recording paper 2 is detected by the front end detecting sensor 25.

A user inputs a print size by operating the size specifying key of the operation panel 50. The user then operates the print key, thereby the transport roller pair 24 starts transporting the recording paper 2 to the recording position. When a front edge of the recording area of the thermal recording paper 2 reaches the heating element array 20a, one line of image data of a yellow image is read from the image memory 48, converted by the head driver 42 into driving data at gradation levels in accordance with the image data, and then sent to the thermal head 20.

By supplying electricity to each heating element of the heating element array 20a in accordance with the driving data for one line, the thermal head 20 generates thermal energy corresponding to the coloring degree of each pixel. After the first line of the yellow image is thermally recorded on the thermal recording paper 2, the thermal recording paper 2 is transported by a pixel and the second line of the yellow image is thermally recorded. The yellow image is thermally recorded line by line by the foregoing process. When a part carrying thermally recorded yellow image reaches the optical fixer 30, the ultraviolet ray lamp 30a emits ultraviolet rays of 420 nm and optically fixes the yellow thermosensitive coloring layer.

After thermal recording of the yellow image, the transport roller pair 24 counterrotates to move the recording paper 2 in the β direction. The transport roller pair 24 is stopped when the edge of the recording area on the recording paper 2 returns to face the heating element array 20a.

The first line of the magenta image is read out from the image data and of the magenta image and converted by the head driver 42 into driving data at gradation levels in accordance with the image data. Each heating element of the heating element array 20a is supplied with electricity in accordance with the driving data, and thereby the first line of the magenta image is recorded in the magenta thermosensitive coloring layer.

After recording the first line of the magenta image, the recording paper 2 is transported by a pixel in the α direction and the second line of the magenta image is thermally recorded. The magenta image is thermally recorded line by line by repeating the foregoing process. When a part carrying thermally recorded magenta image reaches the optical fixer 30, the ultraviolet ray lamp 30b emits near ultraviolet rays of 365 nm and optically fixes the magenta thermosensitive coloring layer.

After optical fixation of the magenta image, the recording paper 2 is returned to the recording start position and a cyan image is thermally recorded line by line in the recording area. The optical fixer does not optically fix the cyan image. The recording area carrying the full-color image is transported to the outside of the thermal printer 11 by discharge roller pair 33. After one frame of the recording paper 2 is transported, the cutter 32 is operated to cut the recording paper 2 into a sheet. The sheet of the recording paper 2 is discharged on a discharge tray (not shown) outside the thermal printer 11.

When the thermal recording paper 2 is running out, the end hole 2b is detected by the end hole detective sensor 17 (ST1), as shown in FIG. 4. The detection signal from the end hole detective sensor 17 is converted into digital detection data by the A/D converter 47 and inputted into the microcomputer 40. The microcomputer 40 suspends feeding of the recording paper 2 by the feed roller pair 22 (ST2) and simultaneously sounds an alarm 54 as well as displaying a message “The thermal recording paper is running out” on an LCD panel 55 (ST3).

Subsequently, the microcomputer 40 reads the diameter d0 of the core 4 from the EEPROM 52 and calculates the positions of the rear edge marks and the end hole marks (ST4). Note that since the d0 is 50.8 mm and thus the peripheral length L is 160 mm, the rear edge marks 5c and 5d and the end hole marks 6b and 6a are formed at intervals of 160 mm from the end hole 2b. Between the end hole 2b and the rear edge 2a, the rear edge mark 5a alone is formed at 160 mm from the end hole 2b.

The end hole 2b faces the end hole detective sensor 17 such that the positions of the rear edge marks and the end hole marks are identified accordingly. The end hole mark 6a is formed near the feed roller pair 22, and the end hole mark 6b is formed between the transport roller pair 24 and the front end detective sensor 25. The position of the rear edge mark 5a between the end hole 2b and the rear edge 2a is identified by the distance from the end hole 2b.

If the microcomputer 40, at the point the end hole 2b is detected, judges that the image frame under printing will overlap the end hole mark 6b (ST5), it displays the message “Printing suspended” on the LCD panel 55 (ST6) and then cancels the print command inputted already (ST7). If the image frame does not overlap the end hole mark 6b, the printing is continued.

Since there are two printable areas 9d and 9c after the end hole mark 6b as shown in FIG. 1 when the print command is cancelled, the microcomputer 40 displays the message “Two L-size prints printable” on the LCD panel 55 to suggest the user to select the L-size printing (ST8). If the user presses a cancel key or operates nothing for a predetermined period, the microcomputer 40 displays the message “Printing finished” on the LCD panel 55 (ST9) and then finishes a print sequence.

If the user selects the L-size printing by operating the size specifying key on the operation panel 50 and then operates the print key, the microcomputer 40 sets the recording start position avoiding the disposal areas 7d and 7c (ST 10) and then starts printing (ST11). In this printing, the transport roller pair 24 is driven to move the recording paper 2, such that the edge of the printable area 9d is placed under the heating element array 22a. Then, each yellow, magenta and cyan image is sequentially printed in the printable area 9d by the foregoing print sequence.

When a boundary between the printable area 9d carrying the image frame and the disposal area 7d reaches the cutter 32, the cutter 32 is operated to cut the recording paper 2. Subsequently, the recording paper 2 is transported in the a direction by 127 mm and cut by the cutter 32. The L-size print printed on the printable area 9d is thereby discharged into the discharge tray via the discharge opening 11.

Afterward, the transport roller pair 24 conuterrotates to move the recording paper in the 1 direction. When the edge of the printable area 9c reaches the heating element array 20a, the drive of the transport roller pair 24 is stopped and another image frame of L-size is printed on the printable area 9c. When the printing is finished, the printable area 9c carrying the image frame is cut into the L-size print and discharged in the foregoing sequence. The remaining recording paper 2 after the end hole 2b is discharged via the discharge opening 11a without printed. Note that the adhesive tape 3 is easily detached from the core 4 by the drawing force of the feed roller pair 22.

Although the recording paper after the end hole 2b is wasted owing to the foregoing physical limitations, it is possible to print in the printable areas 9b and 9a if the physical limitations are overcome by additional transport roller pair and the like.

Note that the numeric values of the recording paper in the above embodiment are illustrative and the present invention is not limited to them. For example, the recording paper may have the width of 127 mm instead of 89 mm. In this case, the core is thickened to enable two 2L-size prints to be printed in each printable area 9d and 9c.

Note that the present invention is applicable to a thermal transfer printer and an inkjet printer as well as the thermal printer. Furthermore, the present invention is also applicable to a facsimile.

Although the present invention has been described with respect to the preferred embodiments, the present invention is not to be limited to the above embodiments but, on the contrary, various modifications will be possible to those skilled in the art without departing from the scope of claims appended hereto.

1. A roll paper comprising:
a core having a cylindrical shape;
a continuous recording paper wound many times about said core and having a rear edge fixed to said core, said recording paper having a plurality of rear edge marks being formed at a predetermined pitch by a step between said rear edge and said core; and
an end hole formed to overlap one of said rear edge marks on said recording paper, said end hole indicating running out of said recording paper.

2. A roll paper defined in claim 1, wherein said end hole is positioned at 2×L from said rear edge, providing that said L represents a peripheral length of said core.

3. A roller paper defined in claim 2, wherein said end hole has a circular shape and a center of said end hole is positioned on said rear edge mark.

4. A roll paper defined in claim 3, wherein said rear edge is fixed to said core with a tape.

5. A printer to print an image frame on a continuous recording paper drawn from a roll paper, said recording paper being wound around a periphery of a core and having an end hole formed to overlap one of said rear edge marks, said printer comprising:
a sensor for detecting said end hole;
a control part for controlling a size and a recording start position of said image frame in order to print said image frame on said recording paper avoiding disposal areas with a predetermined width including said rear edges, said rear edge marks identified based on the position of said end hole detected by said sensor and a peripheral length of said core.

6. A printer defined in claim 5, wherein said disposal area is wider than a diameter of said end hole.

7. A printer defined in claim 6, wherein said sensor is disposed near said roll paper.

8. A printer defined in claim 7, wherein said control part prohibits printing of said image frame in a area from said end hole to said rear edge.

9. A print method for recording an image frame on a continuous recording paper drawn from a roll paper, said recording paper being wound around a periphery of a core and having an end hole formed to overlap one of said rear edge marks, said print method comprising;
detecting said end hole;
calculating positions of each rear edge mark based on the detected position of said end hole and a peripheral length of said core;
determining specific printable frame size and the printable number based on the positions of each rear edge mark;
suspending printing in case of an overlap of said image frame under printing and a disposal area with a predetermined width including said rear edge mark;
displaying said specific printable frame size and said printable number for confirmation after print suspension; and
printing said image frame in said specific printable frame size on said recording paper based on a print command while avoiding said disposal area.

10. A print method defined in claim 9, wherein printing is not performed in an area from said end hole to said rear edge.
